(19) United States
(12) Patent Application Publication
(10) Pub. No.: US 2020/0285527 A1
(43) Pub. Date: Sep. 10, 2020

(54) DETERMINATION METHOD, INFORMATION PROCESSING APPARATUS, AND STORAGE MEDIUM

(71) Applicant: FUJITSU LIMITED, Kawasaki-shi (JP)

(72) Inventors: Nobuyuki KUROMATSU, Kawasaki (JP); Haruyasu Ueda, Ichikawa (JP)

(73) Assignee: FUJITSU LIMITED, Kawasaki-shi (JP)

(21) Appl. No.: 16/805,956

(22) Filed: Mar. 2, 2020

(30) Foreign Application Priority Data
Mar. 5, 2019 (JP) 2019-039829

(51) Int. Cl. G06F 9/50; G06Q 10/06; G06F 9/54

(52) U.S. Cl. CPC G06F 9/5083; G06F 9/547; G06Q 10/06315

(57) ABSTRACT

A determination method executed by a computer, the determination method includes obtaining a service desired by a user; identifying a resource of the obtained service; when a container to perform the obtained service is not started in the identified resource, calculating, for each of a plurality of candidate containers to be stopped, a degree of influence exerted on the user when a candidate container is stopped, the calculating being performed by using a starting time period of the candidate container, a response time period for the service to be performed, a required resource of a container, and a frequency of a request for the service to be performed; stopping at least one container for securing the identified resource among the plurality of candidate containers based on the calculated degree of influence; and starting the container to perform the obtained service by using a resource for the at least one container.

### CROSS-REFERENCE TO RELATED APPLICATION

This application is based upon and claims the benefit of priority of the prior Japanese Patent Application No. 2019-39829, filed on Mar. 5, 2019, the entire contents of which are incorporated herein by reference.

### FIELD

The embodiments discussed herein are related to a determination method, an information processing apparatus, and a storage medium.

### BACKGROUND

Serverless architectures have recently been known as a technology for building an execution environment that provides services without requiring a server (for example, refer to Japanese Laid-open Patent Publication No. 2017-167763, Japanese Laid-open Patent Publication No. 2017-097642, Japanese Laid-open Patent Publication No. 2017-174038, International Publication Pamphlet No. WO 2008/084826, and International Publication Pamphlet No. WO 2006/059650).

### SUMMARY

According to an aspect of the embodiments, a determination method executed by a computer, the determination method includes obtaining a service desired by a user; identifying a resource of the obtained service; when a container to perform the obtained service is not started in the identified resource, calculating, for each of a plurality of candidate containers to be stopped, a degree of influence exerted on the user when a candidate container is stopped, the calculating being performed by using a starting time period of the candidate container, a response time period for the service to be performed, a required resource of a container, and a frequency of a request for the service to be performed; stopping at least one container for securing the identified resource among the plurality of candidate containers to be stopped based on the calculated degree of influence; and starting the container to perform the obtained service by using a resource for the at least one container.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of processing of a system including an information processing apparatus according to an embodiment;

FIG. 2 is a functional block diagram illustrating a configuration of an information processing apparatus according to an embodiment;

FIG. 3 is a diagram illustrating an example of container information according to an embodiment;

FIG. 4 is a diagram illustrating an example of API usage logs according to an embodiment;

FIG. 5 includes diagrams for explaining calculation of indexes according to an embodiment;

FIG. 6 is a diagram illustrating an example of pseudocode for calculating a reference time according to an embodiment;

FIG. 7 is a diagram illustrating an example of a flowchart of a container management process according to an embodiment;

FIG. 8 is a diagram illustrating an example of a flowchart of a container-to-be-stopped determination process according to an embodiment;

FIGS. 9A and 98 are diagrams illustrating an example of a sequence of container-to-be-stopped determination according to an embodiment; and

FIG. 10 is a diagram illustrating an example of a computer that executes a container-to-be-stopped determination program.

### DESCRIPTION OF EMBODIMENTS

In such a serverless architecture, the developer of a service registers in advance a process as the service of the serverless architecture. When execution conditions of a Web application programming interface (API) corresponding to the registered process are satisfied, the serverless architecture starts a container that is executable for the process and returns a response to a request made for the process. A container that has not been used for a certain time period is automatically stopped and will not be started until the container is next invoked. Examples of the service of a serverless architecture include “AWS Lambda (registered trademark)”, “Azure Functions (registered trademark)”, “Google Cloud Functions (registered trademark)”, and the like.

In a serverless architecture, a container may consistently continue to operate if there are sufficient required computational resources, whereas it is desirable to increase efficiency of computational resources if the required computational resources are not sufficiently provided. To increase the efficiency of computational resources, repeating stopping and starting of a container as required is known.

For example, it takes a few seconds to a few minutes to start a container in accordance with the content of a process to be executed. If a container is started, a response to a request from a user may be returned in a few seconds. However, when a container of a service that takes a few minutes to start is stopped, a user who subsequently sends a request for this service will wait for a starting time period of the container and a processing time period in the container. The user knows that there are variations among responses of services and that there are a few cases where a wait time increases. However, although the user permits an increase in wait time if the increase occurs at a frequency of about once in 10,000 requests, the user does not permit the delay in response at a frequency of once every several times, which is caused by frequent stops of containers. By way of example, even when a container with a starting time period of a few minutes is preferentially stopped, in the case where the usual latency of the content is 1 millisecond (ms), the starting time period is added to the response time period, such that the response time period suddenly increases several thousand times. It is therefore not necessarily good to preferentially stop a container with a starting time period of a few minutes. In addition, to release computational resources for staring a new container, it is conceivable to stop one container that requires enormous computational resources and to stop a plurality of containers each of which requires small-scale computational resources, but it is not obvious which is better. In view of the above, when computational resources are limited, in starting up a new service in a container, it is desirable to determine a container to be stopped.

Hereinafter, embodiments of a method for determining a container to be stopped (hereinafter referred to as a container-to-be-stopped determination method), an information processing apparatus, and a non-transitory computer-readable storage medium storing a container-to-be-stopped determination program, which are disclosed herein, will be described in detail with reference to the drawings. The present disclosure is not limited by embodiments.

### Embodiments

[Example of Processing of System Including Information Processing Apparatus]

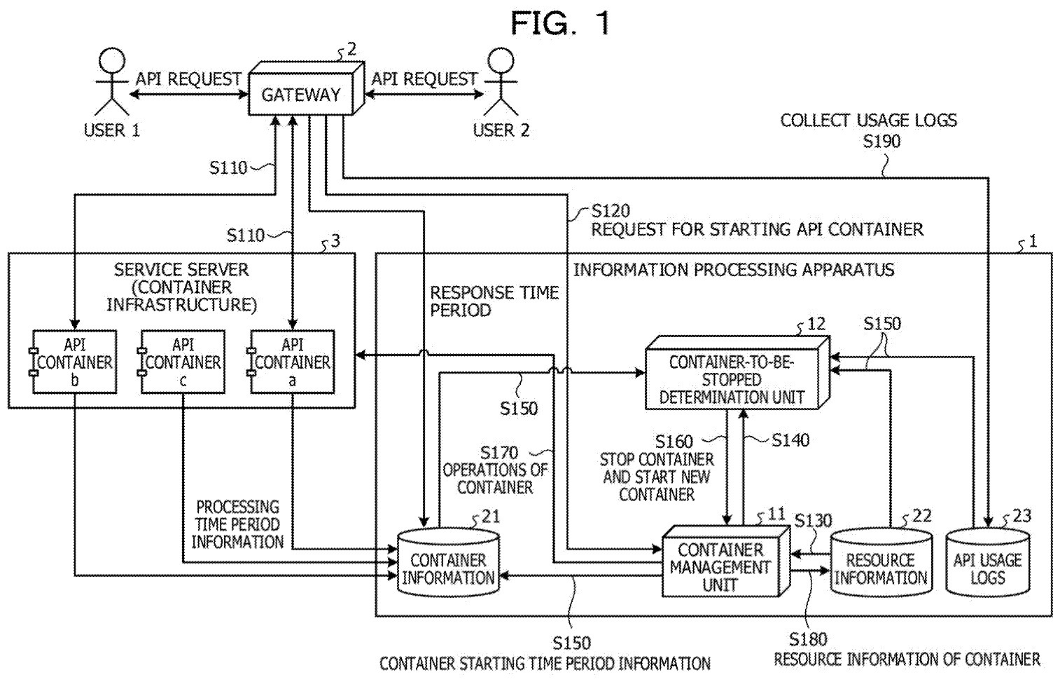

FIG. 1 is a diagram illustrating an example of processing of a system including an information processing apparatus according to an embodiment. As illustrated in FIG. 1, the system includes an information processing apparatus 1, a gateway 2, and a service server 3. The information processing apparatus 1 includes a portion that stores information regarding containers of Web services, a portion that determines, based on the stored information, the starting and stopping of containers, and a portion that actually performs the starting and stopping of containers. The portion that stores information regarding the containers of Web services includes container information 21, resource information 22, and API usage logs 23. The portion that determines, based on the stored information, the starting and stopping of containers includes a container-to-be-stopped determination unit 12. The portion that actually performs the starting and stopping of containers includes a container management unit 11. The service server 3 is a container execution infrastructure.

When a user makes a request for an API, the gateway 2 sends the request to a container of a Web service for the API if the container is started on the service server 3, and receives a response (S110). The gateway 2 then returns the received response to the user. At this point, the container of the Web service records information on the processing time period taken for processing in the container information 21. The gateway 2 records a response time period taken for processing of the response in the container information 21.

If the container of the Web service for the API is not started on the service server 3, the gateway 2 requests the information processing apparatus 1 to start the container (S120).

The container management unit 11 of the information processing apparatus 1 uses the resource information 22 to verify whether resources are available for starting the container whose start is requested (S130). If the resources are not available, the container management unit 11 inquires of the container-to-be-stopped determination unit 12 which container is to be stopped (S140).

The container-to-be-stopped determination unit 12 calculates, for each of candidate containers to be stopped, the degree of influence (index) exerted on a user when the container is stopped, using the starting time period, the response time period for a Web service being performed in the container, the resources required for the Web service being performed in the container, and the frequency of requests for the Web service being performed in the container (S150). The starting time period and the response time period of a container are stored in the container information 21. Information on the resources is stored in the resource information 22. The frequency of requests is obtained from information stored in the API usage logs 23. Based on the calculated degree of influence, the container-to-be-stopped determination unit 12 determines a container to be stopped among the candidate containers to be stopped. The container-to-be-stopped determination unit 12 notifies the container management unit 11 of the container to be stopped (S160).

For securing resources required for starting a container to be started, the container management unit 11 stops the container to be stopped and starts the container to be started (S170). At this point, the container management unit 11 creates records in the resource information 22 for the resources released by stopping and creates records in the resource information 22 for the resources used by starting (S180).

The gateway 2 records the type of the used container of the Web service in the API usage logs 23 (S190).

In such a manner, in the case of limited computational resources, in starting a container of a new service, the information processing apparatus 1 may determine a container to be stopped by using the degree of influence exerted on a user when each candidate container to be stopped is stopped.

[Configuration of Information Processing Apparatus]

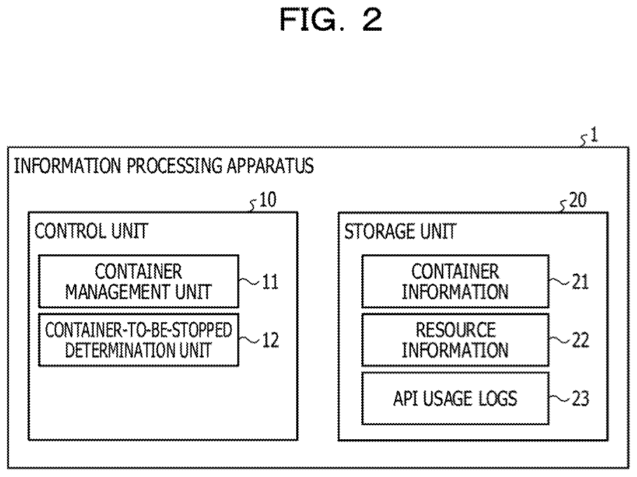

FIG. 2 is a functional block diagram illustrating a configuration of an information processing apparatus according to an embodiment. As illustrated in FIG. 2, the information processing apparatus 1 includes a control unit 10 and a storage unit 20.

The control unit 10 is an electronic circuit, such as a central processing unit (CPU). The control unit 10 includes an internal memory for storing programs defining various processing procedures and control data, and executes various types of processing using the programs and the data. The control unit 10 includes the container management unit 11 and the container-to-be-stopped determination unit 12. The container management unit 11 is an example of an identifying unit, a stopping unit, and starting unit. The container-to-be-stopped determination unit 12 is an example of a calculating unit and the stopping unit.

The storage unit 20 is a semiconductor memory device, such as a random-access memory (RAM) or a flash memory, or a storage device, such as a hard disk or an optical disk. The storage unit 20 contains the container information 21, the resource information 22, and the API usage logs 23.

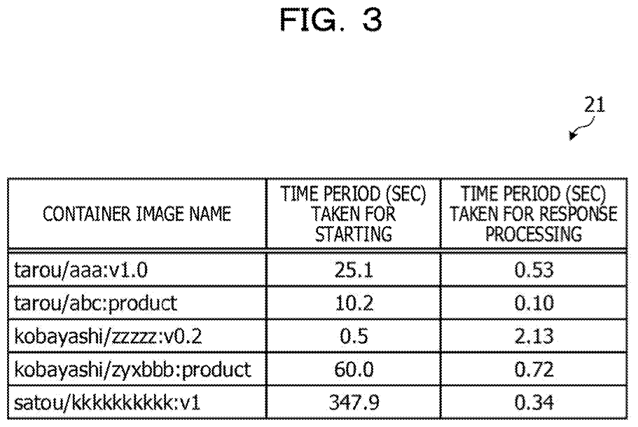

The container information 21 is information in which the starting time period of a container, the processing time period for a response, and the like are associated with each other. An example of the container information 21 will now be described with reference to FIG. 3.

FIG. 3 is a diagram illustrating an example of container information according to an embodiment. As illustrated in FIG. 3, the container information 21 is information in which the time taken for starting (starting time period) and the time taken for response processing (response time period) are associated with a container image name. The container image name represents the name of an image for a container and may be the type of a container of a Web service. The container is created based on an image. The image is created by the Web service of an API.

The time taken for starting (starting time period) represents a time period for staring a container by using an image represented by a container image name. By way of example, the starting time period is a time taken from when the container management unit 11 described later issues an instruction for starting a container to when the starting processing for the container is complete. The starting time period may be recorded in the container information 21 by the container management unit 11.

The time taken for response processing (response time period) represents a time period from when a user makes a request to when a container returns a result to the user. By way of example, the response time period is a time period from when the gateway 2 makes a request for the API to a container to when a response is returned from the container. The response time period may be recorded in the container information 21 at a timing at which the gateway 2 returns a result (response) to the user. A processing time period described later, which is a time period from when a container begins performing processing for a request to when a result is obtained, is included in the response time period.

By way of example, in the case where the container image name is “tarou/aaa:v1.0”, “25.1 sec” is stored as a time period taken for starting and “0.53 sec” is stored as a time period taken for response processing.

The resource information 22 is information including resources of the service server 3 and resources of containers. Resources required to start a container are included in the resource information 22. The term “resources” as used herein refers to, for example, the capacity of a memory and the processing speed of a CPU.

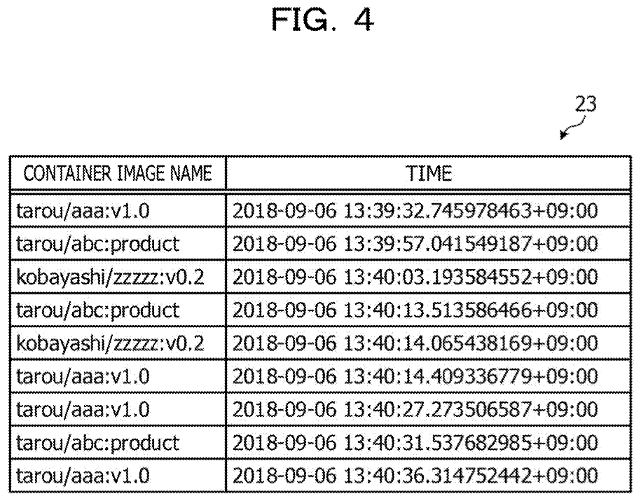

The API usage logs 23 are logs of API usage. The API usage logs 23 are recorded by the gateway 2 each time a request for an API is made by a user. The frequency of requests is obtained from the API usage logs 23. An example of the API usage logs 23 will now be described with reference to FIG. 4.

FIG. 4 is a diagram illustrating an example of API usage logs according to an embodiment. As illustrated in FIG. 4, the API usage logs 23 are information in which the container image name and the time are associated with each other. The container image name represents the name of an image for a container, which is required to perform a Web service for an API, and may be the type of a container of the Web service. The container image name of the API usage logs 23 corresponds to the container image name of the container information 21. The time represents a time point at which a request for an API is made. The time may be a time point at which the request for the API is completed.

By way of example, in the case where the container image name is “tarou/aaa:v1.0”, “2018-09-06 13:39:32 . . . .” is stored as a time.

The container management unit 11 manages containers.

For example, upon receiving a request for starting a container, the container management unit 11 uses the resource information 22 to determine whether the resources used when starting a specified container are available. If the resources used when starting the specified container are available, the container management unit 11 starts the container.

If the resources used when staring the specified container are not available, the container management unit 11 inquires of the container-to-be-stopped determination unit 12 about a container to be stopped for staring the specified container. As a result of inquiry, the container management unit 11 stops a container to be stopped. Thereafter, the container management unit 11 starts the specified container.

The container management unit 11 records the starting time period for the specified container in the container information 21. The container management unit 11 updates the resource information 22 with information on the resources of the specified container.

The container-to-be-stopped determination unit 12 determines a container to be stopped. For example, upon receiving an inquiry request for a container to be stopped from the container management unit 11, the container-to-be-stopped determination unit 12 calculates, for each of candidate containers to be stopped, the degree of influence (index) exerted on a user when the candidate container to be stopped is stopped. For example, for the candidate container to be stopped, the container-to-be-stopped determination unit 12 calculates the degree of influence (index) using the starting time period, the response time period for a service to be performed, the required resources, and the frequency of requests for the service to be performed. The starting time period and the response time period for the service of the candidate container to be stopped are each obtained from the container information 21. The resources required for the candidate container to be stopped are obtained from the resource information 22. The frequency of requests for the service of the candidate container to be stopped is obtained from the API usage logs 23. The candidate containers to be stopped are containers currently operating in the service server 3, and information of the candidate containers to be stopped are, for example, obtained from Web service information managed with the service server 3. Based on the calculated degree of influence, the container-to-be-stopped determination unit 12 determines a container, or a set of containers, with the smallest degree of influence as a container to be stopped, in order to secure resources required for starting a container to be started. A set of containers is included in a container to be stopped for the purposes of securing resources required for starting a container to be started. That is, there are some cases where it is hard to secure resources required for starting a container to be started from only one container, and therefore a set of containers is included in a container to be stopped.

The degree of influence, as used herein, refers to an index of how much container stopping influences a user. For example, the degree of influence refers to an index for the wait time of a user. A method for calculating the degree of influence is, for example, as follows. By way of example, the container-to-be-stopped determination unit 12 calculates, for each candidate container to be stopped, a first total response time period taken when the candidate container to be stopped continues to operate without being stopped. The first total response time period is obtained from the frequency of requests within a time period functioning as a reference (reference time period) and the response time period. The container-to-be-stopped determination unit 12 calculates, for each candidate container to be stopped, a second total response time period taken when the candidate container to be stopped is started while stopped. The second total response time period is obtained from a starting time period as well as the frequency of requests within the reference time period and the response time period. The container-to-be-stopped determination unit 12 calculates, for each candidate container to be stopped, the ratio obtained when comparing the second total response time period with the first total response time period, as the degree of influence (index). The reference time period may be calculated from a response time period, the starting time period of a container, and the number of responses from a user that reach within a reference time period. An example of pseudocode for calculating the reference time period will be described later.

[Calculation of Index]

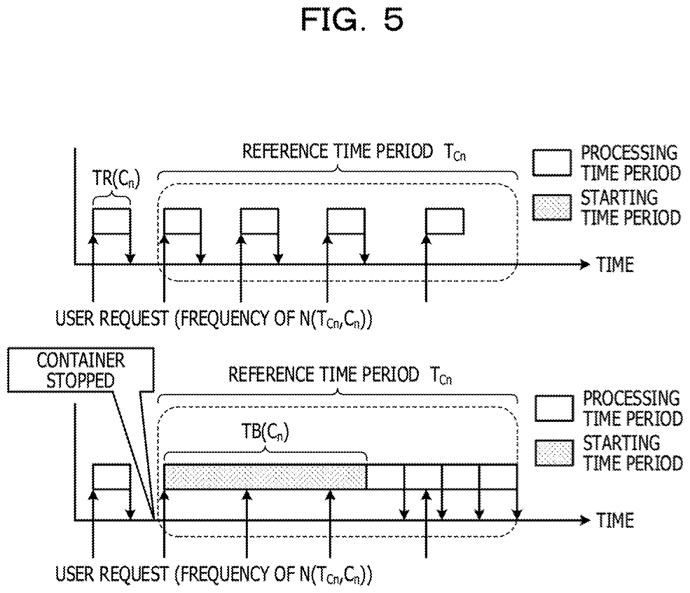

Calculation of an index according to an embodiment will now be described with reference to FIG. 5. FIG. 5 includes diagrams for explaining calculation of an index according to an embodiment. The upper diagram in FIG. 5 illustrates a situation where a container continues to operate as is without being stopped. The lower diagram in FIG. 5 illustrates a situation where, after a container is stopped, the container is started again. T_{Cn} is a reference time period. TR(Cn) denotes the response time period (including the processing time period) of a container Cn. For convenience, TR(Cn) is assumed here to be fixed. TB(Cn) denotes the starting time period of the container Cn. N(T_{Cn},Cn) denotes the frequency of requests within the reference time period of the container Cn.

As illustrated in the upper diagram in FIG. 5, the container-to-be-stopped determination unit 12 calculates, for the candidate container Cn to be stopped, a first total response time period obtained from the frequency of requests N(T_{Cn},Cn) within the reference time period T_{Cn} and the response time period TR(Cn). The first total response time period is a total response time period taken when the candidate container Cn to be stopped continues to operate without being stopped. For example, the first total response time period of the container Cn is calculated by the following equation (1).

A(Cn)=N(T_{Cn},Cn)×TR(Cn) (1) First total response time period

Since the frequency of requests N(T_{Cn},Cn) within the reference time period T_{Cn} is four, the first total response time period A(Cn) is 4×TR(Cn).

As illustrated in the lower diagram in FIG. 5, the container-to-be-stopped determination unit 12 calculates, for the candidate container Cn to be stopped, a second total response time period obtained from a starting time period TB(Cn) as well as the frequency of requests N(T_{Cn},Cn) within the reference time period T_{Cn} and the response time period TR(Cn). The second total response time period is a total response time period taken when the candidate container Cn to be stopped is started while stopped. For example, the second total response time period of the container Cn is calculated by the following equation (2).

B(Cn)=N(T_{Cn},Cn)×TR(Cn)+TB(Cn) (2) Second total response time period

Since the frequency of requests N(T_{Cn},Cn) within the reference time period T_{Cn} is four, the second total response time period B(Cn) is 4×TR(Cn)+TB(Cn).

The container-to-be-stopped determination unit 12 calculates, for each candidate container Cn to be stopped, the ratio M(Cn) obtained when comparing the second total response time period B(Cn) with the first total response time period A(Cn), as the degree of influence (index). For example, the degree of influence (index) exerted when the container Cn is stopped is calculated by the following equation (3).

M(Cn)=B(Cn)/A(Cn) (3) Index

The container-to-be-stopped determination unit 12 calculates the degree of influence (index) M(Cn) for each candidate container to be stopped. To make available resources required for starting a new container, the container-to-be-stopped determination unit 12 determines a container with the smallest degree of influence (index) or a set of containers with the smallest sum of degrees of influence (indexes) as a container to be stopped.

[Pseudocode for Calculating Reference Time Period]

A method for calculating a reference time period will now be described. By way of example, the container-to-be-stopped determination unit 12 performs the following processing for each candidate container to be stopped. The container-to-be-stopped determination unit 12 determines the number of requests made during the starting time period for the candidate container to be stopped. The container-to-be-stopped determination unit 12 determines, for the number of requests made during the starting time period, a respective response time period for returning a response to each of the requests. When there is a request further made during return of a response, the container-to-be-stopped determination unit 12 adds a response time period for returning a response to the request. When there is no request further made during return of a response or when no request is further made during the added response time period, the container-to-be-stopped determination unit 12 calculates, as a reference time period, a time period from initiation of start of a container to completion of the final response time period.

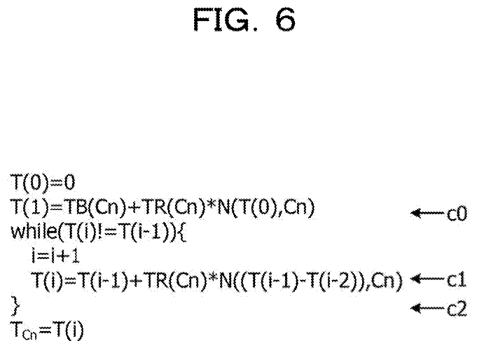

FIG. 6 is a diagram illustrating an example of pseudocode for calculating a reference time according to an embodiment. T_{Cn} is the reference time period. TR(Cn) denotes the response time period (including the processing time period) of the container Cn. TB(Cn) denotes the starting time period of the container Cn. N(T,Cn) denotes the frequency of requests in T seconds of the container Cn. Here, i denotes an index. T denotes an elapsed time period.

As illustrated in FIG. 6, there is no request made in “0” hours of the elapsed time period T(0) as indicated by the code of reference character c0, and therefore the container-to-be-stopped determination unit 12 sets TB(Cn) for T(1). For example, the elapsed time period corresponding to the starting time period of the container Cn is set for T(1). Next, the container-to-be-stopped determination unit 12 performs the following processing until T(1) matches T(i−1). For example, as indicated by the code of reference character c1, the container-to-be-stopped determination unit 12 adds, to a starting time period T(1), the response time period TR(Cn) multiplied by the number N of requests made in the starting time period (=T(1)−T(0)), and sets the value obtained by the addition for an elapsed time period T(2). Further, if there is a request further made in a time period (=T(2)−T(1)) when a response is returned in the elapsed time period T(2), as indicated by the code of reference character c1, the container-to-be-stopped determination unit 12 adds the response time period TR(Cn) multiplied by the number N of requests and sets the value obtained by the addition for an elapsed time period T(3). When T(i) matches T(i−1), as indicated by the code of reference character c2, the container-to-be-stopped determination unit 12 calculates T(i), which is a time period from initiation of start of a container to completion of the final response time period, as a reference time period T_{Cn}.

[Flowchart of Container Management Process]

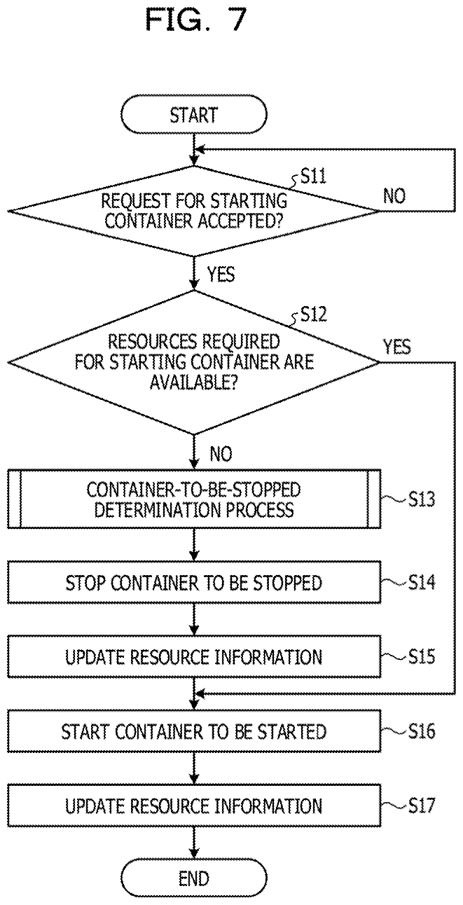

FIG. 7 is a diagram illustrating an example of a flowchart of a container management process according to an embodiment.

As Illustrated in FIG. 7, the container management unit 11 determines whether the container management unit 11 has accepted a request for starting a container (step S11). If it is determined that the container management unit 11 has not accepted a request for starting a container (No in step S11), the container management unit 11 repeats the determination processing until accepting a request for starting a container.

If, however, it is determined that the container management unit 11 has accepted a request for starting a container (Yes in step S11), the container management unit 11 determines, by referencing the resource information 22, whether the resources required for starting the container for which the starting request has been made are available (step S12). If it is determined that the resources required for starting a container are available (Yes in step S12), the container management unit 11 proceeds to step S16 to start the container.

If, however, it is determined that resources required for starting the container for which the starting request has been made are not available (No in step S12), the container management unit 11 performs a container-to-be-stopped determination process (step S13). For example, the container management unit 11 requests the container-to-be-stopped determination unit 12 to determine a container to be stopped in order to start the container for which the starting request has been made. The flowchart of the container-to-be-stopped determination process will be described later.

Subsequently, the container management unit 11 stops the container to be stopped determined by the container-to-be-stopped determination process (step S14). The container management unit 11 updates the resource information 22 (step S15).

The container management unit 11 starts a container to be started for which the starting request has been made (step S16). The container management unit 11 updates the resource information 22 (step S17). Thus, the container management unit 11 completes the container management process.

[Flowchart of Container-to-Be-Stopped Determination Process]

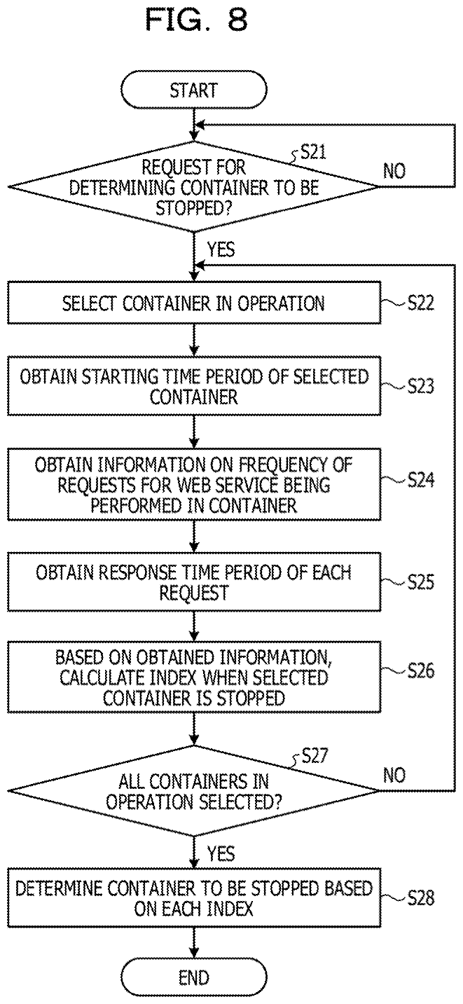

FIG. 8 is a diagram illustrating an example of a flowchart of a container-to-be-stopped determination process according to an embodiment.

As illustrated in FIG. 8, the container-to-be-stopped determination unit 12 determines whether the container-to-be-stopped determination unit 12 has accepted a request for determining a container to be stopped (step S21). If it is determined that the container-to-be-stopped determination unit 12 has not accepted a request for determining a container to be stopped (No in step S21), the container-to-be-stopped determination unit 12 repeats the determination processing until accepting a request for determining a container to be stopped.

If, however, it is determined that the container-to-be-stopped determination unit 12 has accepted a request for determining a container to be stopped (Yes in step S21), the container-to-be-stopped determination unit 12 selects a container in operation in the service server 3 (step S22).

The container-to-be-stopped determination unit 12 references the container information 21 and obtains the starting time period of the selected container (step S23). The container-to-be-stopped determination unit 12 references the API usage logs 23 and obtains information on the frequency of requests for a Web service being performed in the selected container (step S24). The container-to-be-stopped determination unit 12 references the container information 21 and obtains the response time period of each request (step S25). Based on the obtained information, the container-to-be-stopped determination unit 12 calculates the degree of influence (Index) exerted when the selected container is stopped (step S26). The container-to-be-stopped determination unit 12 may calculate the degree of influence (index) based on equation (1), equation (2), and equation (3).

The container-to-be-stopped determination unit 12 determines whether the container-to-be-stopped determination unit 12 has selected all the containers in operation in the service server 3 (step S27). If it is determined that the container-to-be-stopped determination unit 12 has not selected all the containers (No in step S27), the container-to-be-stopped determination unit 12 proceeds to step S22 to select the next container.

If, however, it is determined that the container-to-be-stopped determination unit 12 has selected all the containers (Yes in step S27), the container-to-be-stopped determination unit 12 determines a container to be stopped based on each degree of influence (index) in order to secure resources required for starting a container to be started (step S28). For example, for securing resources required for starting a container to be started, the container-to-be-stopped determination unit 12 determines a container, or a set of containers, with the smallest degree of influence. Thus, the container-to-be-stopped determination unit 12 completes the container determination process.

[Sequence of Container-to-Be-Stopped Determination]

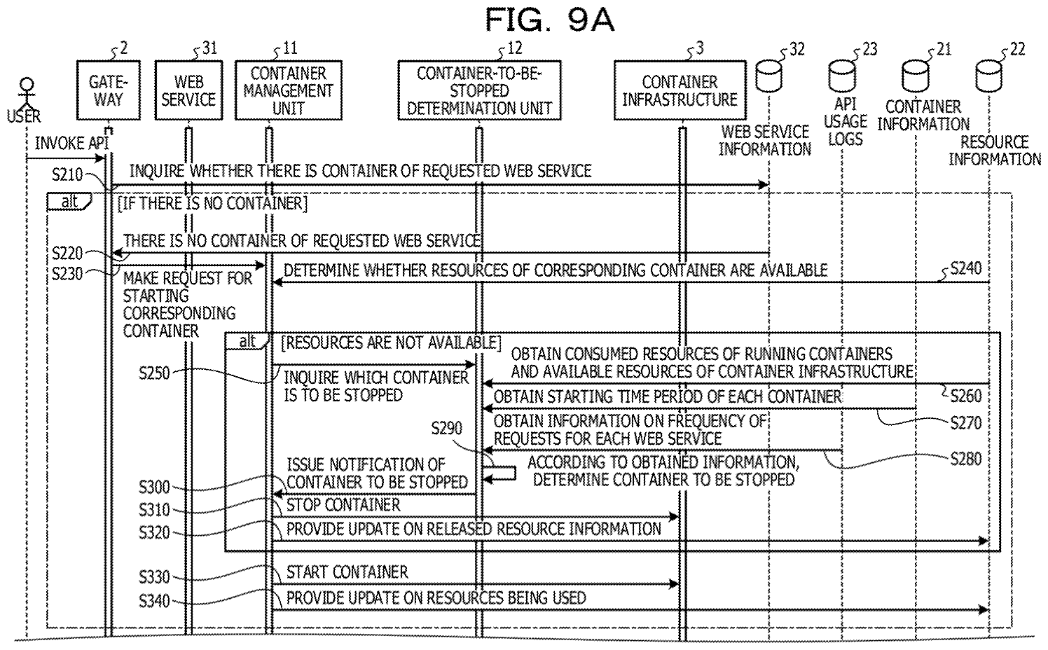

FIGS. 9A and 9B are diagrams illustrating an example of a sequence of container-to-be-stopped determination according to an embodiment. A Web service 31 in FIG. 9A is assumed as a Web service being performed in a container in operation in the service server 3. The Web service information 32 is assumed as information on a Web service managed with the service server 3.

The gateway 2 that has accepted a request for a Web API from a user inquires of the Web service information 32 whether there is a container of a Web service for the API for which the request has been made (S210). Upon, as a result of the inquiry, accepting that there is no container of the Web service for the API for which the request has been made (S220), the gateway 2 requests the container management unit 11 to start a container corresponding to the Web service (S230).

The container management unit 11 determines, by referencing the resource information 22, whether the resources of a container corresponding to the Web service are available (S240). If it is determined that the resources are not available, the container management unit 11 inquires of the container-to-be-stopped determination unit 12 which container is to be stopped (S250).

The container-to-be-stopped determination unit 12 obtains the consumed resources of each running container and available resources of the container infrastructure from the resource information 22 (S260). The container-to-be-stopped determination unit 12 references the container information 21 and obtains the starting time period of the selected container (S270). The container-to-be-stopped determination unit 12 obtains, from the API usage logs 23, information on the frequency of requests for each Web service performed in the respective container (S280). According to the obtained information, the container-to-be-stopped determination unit 12 determines a container to be stopped and notifies the container management unit 11 of the container to be stopped (S290, S300).

Upon being notified, the container management unit 11 stops a container to be stopped (S310). The container management unit 11 updates the resource information 22 with information on the resources released by stopping of the container (S320).

The container management unit 11 starts the container of the Web service for the API for which the request has been made (S330). The container management unit 11 updates the resource information 22 with information on the resources being used by the container (S340).

The gateway 2 records the time and the type of the used Web service in the API usage logs 23 (S350). Examples of the type of the used Web service include a container image name.

The gateway 2 performs routing and sends the request to the Web service 31 of the corresponding container (S360). The Web service 31 performs processing for the request (S370). The Web service 31 records the processing time period in the container information 21 (S380). The Web service 31 returns a response to the request to the gateway 2 (S390). The gateway 2 then returns the response to the request back to the user (S400).

### Effects of Embodiment

According to the embodiment, the information processing apparatus 1 obtains a service desired by a user. The information processing apparatus 1 identifies a resource of the obtained service. When a container to perform the obtained service is not started, for each of a plurality of candidate containers to be stopped, the information processing apparatus 1 calculates the degree of influence on a user when the candidate container to be stopped is stopped, using a starting time period, a response time period for the service to be performed, a required resource, and a frequency of a request for the service to be performed. Based on the calculated degree of influence, the information processing apparatus 1 stops a container for securing the identified resource among the plurality of candidate containers to be stopped. The information processing apparatus 1 then starts a container of the obtained service. According to such a configuration, when computational resources are limited, in starting up a new service desired by a user in a container, the information processing apparatus 1 may use indexes to determine a container to be stopped.

According to the embodiment described above, the information processing apparatus 1 calculates, for each of the plurality of candidate containers to be stopped, a first total response time period taken when the candidate container to be stopped continues to operate without being stopped. The first total response time period is obtained from the frequency of requests within a certain period and the response time period. The information processing apparatus 1 calculates, for each of the plurality of candidate containers to be stopped, a second total response time period taken when the candidate container to be stopped is started while stopped. The second total response time period is obtained from the starting time period as well as the frequency of requests within the certain period and the response time period. The information processing apparatus 1 calculates, for each of the plurality of candidate containers to be stopped, a ratio obtained when comparing the second total response time period with the first total response time period, as the degree of influence. According to such a configuration, the information processing apparatus 1 converts the degree of influence on a user into a numerical form and thereby may use the degree of influence to determine a container to be stopped.

In addition, according to the embodiment described above, for securing the identified resource, the information processing apparatus 1 stops a container or a container group whose degree of influence is smallest among the plurality of candidate containers to be stopped. According to such a configuration, the information processing apparatus 1 may stop such a container as to have the smallest influence on a user.

In addition, according to the embodiment described above, the information processing apparatus 1 obtains the number of requests made during the starting time period for a candidate container to be stopped. The information processing apparatus 1 obtains, for the obtained number of requests, a respective response time period for returning a response to each of the requests. When there is a request further made during return of the response, the information processing apparatus 1 adds a response time period for returning a response to the request. When there is no request further made during return of the response or when a request is not further made during the added response time period, the information processing apparatus 1 calculates a time period from initiation of start of a container to completion of the final response time period as a certain time period for the candidate container to be stopped. According to such a configuration, the information processing apparatus 1 may effectively calculate a certain time period used in determining candidate containers to be stopped.

[Others]

The information processing apparatus 1 in the embodiment described above may be implemented in such a way that an information processing apparatus, such as a known personal computer or a workstation, is provided with the functions of the control unit 10, the storage unit 20, and the like described above.

In the embodiment described above, the constituent components of the devices illustrated in the drawings are not required to be physically configured as illustrated. For example, specific forms of the distribution and integration of the devices are not be limited to those illustrated in the drawings, and all or some of the devices may be functionally or physically distributed or integrated in arbitrary units based on various loads and usage statuses. For example, the container management unit 11 and the container-to-be-stopped determination unit 12 may be integrated together. The container-to-be-stopped determination unit 12 may be distributed to a determination unit that determines a container to be stopped and a calculation unit that calculates a reference time period used when determining a container to be stopped. The storage unit 20 may be coupled via a network as an external device of the information processing apparatus 1.

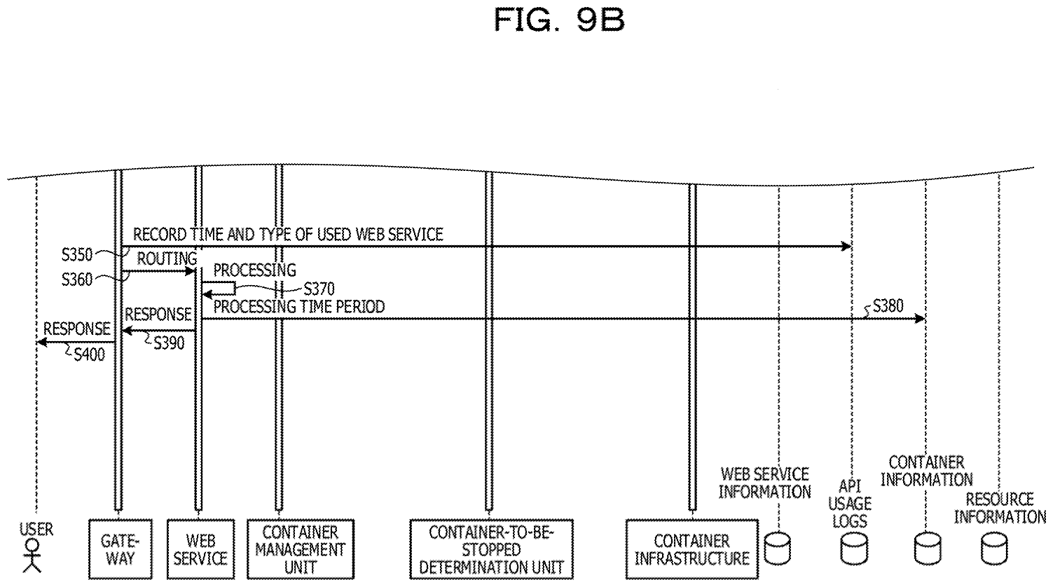

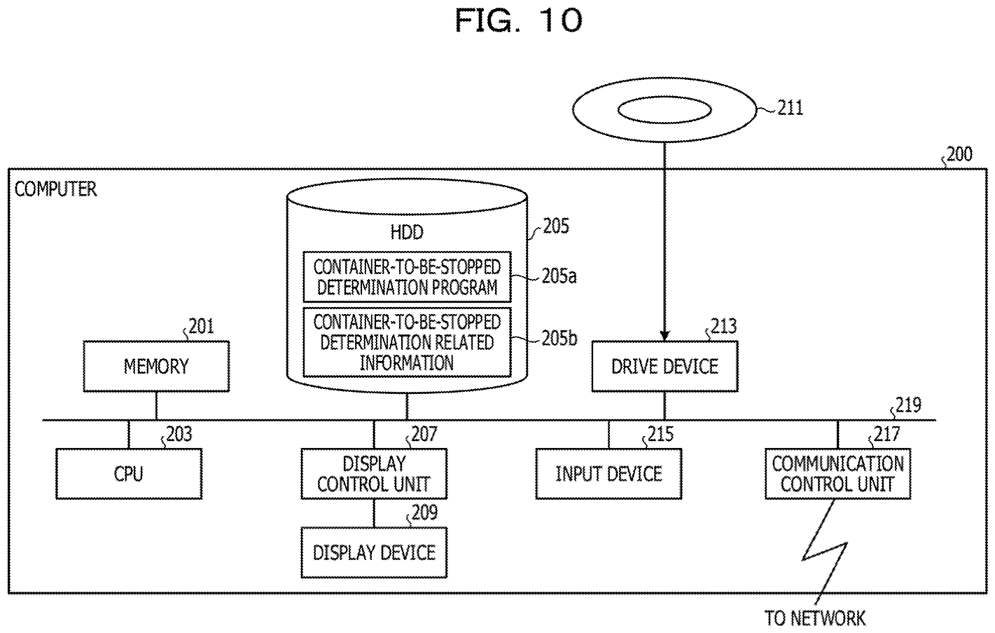

Various types of processing described in the embodiment described above may be implemented by executing a computer program prepared in advance on a computer, such as a personal computer or a work station. An example of a computer that executes a program for implementing the same functions as those of the information processing apparatus 1 illustrated in FIG. 2 will be described below. FIG. 10 is a diagram illustrating an example of a computer that executes a container-to-be-stopped determination program.

As illustrated in FIG. 10, a computer 200 includes a CPU 203 that executes various types of arithmetic processing, an input device 215 that receives input of data from a user, and a display control unit 207 that controls a display device 209. The computer 200 further includes a drive device 213 that reads a program or the like from a storage medium, and a communication control unit 217 that exchanges data with another computer over a network. The computer 200 further includes a memory 201 that temporarily stores various types of information, and a hard disk drive (HDD) 205. The memory 201, the CPU 203, the HDD 205, the display control unit 207, the drive device 213, the input device 215, and the communication control unit 217 are coupled to each other by a bus 219.

The drive device 213 is, for example, a device for a removable disk 211. The HDD 205 stores a container-to-be-stopped determination program 205a and container-to-be-stopped determination related information 205b.

The CPU 203 reads the container-to-be-stopped determination program 205a to load the container-to-be-stopped determination program 205a in the memory 201 and execute the container-to-be-stopped determination program 205a as a process. Such a process corresponds to the function units of the information processing apparatus 1. The container-to-be-stopped determination related information 205b corresponds to the container information 21, the resource information 22, and the API usage logs 23. The removable disk 211, for example, stores various types of information of the container-to-be-stopped determination program 205a and the like.

The container-to-be-stopped determination program 205a is not required to be originally stored in the HDD 205. For example, the program may be stored in a “portable physical medium” to be inserted into the computer 200, such as a flexible disk (FD), a compact disk read-only memory (CD-ROM), a digital versatile disk (DVD), a magnetooptical disk, or an integrated circuit (IC) card. The computer 200 may read the container-to-be-stopped determination program 205a from the portable physical medium and execute the container-to-be-stopped determination program 205a.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A determination method executed by a computer, the determination method comprising:
obtaining a service desired by a user;
identifying a resource of the obtained service;
when a container to perform the obtained service is not started in the identified resource, calculating, for each of a plurality of candidate containers to be stopped, a degree of influence exerted on the user when a candidate container is stopped, the calculating being performed by using a starting time period of the candidate container, a response time period for the service to be performed, a required resource of a container, and a frequency of a request for the service to be performed;
stopping at least one container for securing the identified resource among the plurality of candidate containers to be stopped based on the calculated degree of influence; and
starting the container to perform the obtained service by using a resource for the at least one container.

2. The determination method according to claim 1, wherein the calculating includes:
calculating, for each of the plurality of candidate containers to be stopped, a first total response time period taken when the candidate container to be stopped continues to operate without being stopped, the first total response time period being obtained from a frequency of the request within a certain period and the response time period,
calculating, for each of the plurality of candidate containers to be stopped, a second total response time period taken when the candidate container to be stopped is started while stopped, the second total response time period being obtained from the starting time period as well as the frequency of the request within the certain period and the response time period, and
calculating, for each of the plurality of candidate containers to be stopped, a ratio obtained when comparing the second total response time period with the first total response time period, as the degree of influence.

3. The determination method according to claim 1, wherein the stopping includes
stopping, for securing the identified resource, a container or a container group whose degree of influence is smallest among the plurality of candidate containers to be stopped.

4. The determination method according to claim 2, wherein the calculating includes:
obtaining a number of requests made during the starting time period of the candidate container to be stopped,
obtaining, for the obtained number of requests, a respective response time period for returning a response to each of the requests,
when there is a request further made during return of the response, adding a response time period for returning a response to the request, and
when there is no request further made during return of the response or when a request is not further made during the added response time period, calculating a time period from initiation of start of a container to completion of a final response time period as a certain time period for the candidate container to be stopped.

5. An information processing apparatus comprising:
a memory; and
a processor coupled to the memory and the processor configured to:
obtain a service desired by a user,
identify a resource of the obtained service,
when a container to perform the obtained service is not started in the identified resource, calculate, for each of a plurality of candidate containers to be stopped, a degree of influence exerted on the user when a candidate container is stopped, the calculating being performed by using a starting time period of the candidate container, a response time period for the service to be performed, a required resource of a container, and a frequency of a request for the service to be performed,
stop at least one container for securing the identified resource among the plurality of candidate containers to be stopped based on the calculated degree of influence, and
start the container to perform the obtained service by using a resource for the at least one container.

6. The information processing apparatus according to claim 5, wherein the processor is configured to:
calculate, for each of the plurality of candidate containers to be stopped, a first total response time period taken when the candidate container to be stopped continues to operate without being stopped, the first total response time period being obtained from a frequency of the request within a certain period and the response time period,
calculate, for each of the plurality of candidate containers to be stopped, a second total response time period taken when the candidate container to be stopped is started while stopped, the second total response time period being obtained from the starting time period as well as the frequency of the request within the certain period and the response time period, and
calculate, for each of the plurality of candidate containers to be stopped, a ratio obtained when comparing the second total response time period with the first total response time period, as the degree of influence.

7. The information processing apparatus according to claim 5, wherein the processor is configured to
stop, for securing the identified resource, a container or a container group whose degree of influence is smallest among the plurality of candidate containers to be stopped.

8. The information processing apparatus according to claim 6, wherein the processor is configured to:
obtain a number of requests made during the starting time period of the candidate container to be stopped,
obtain, for the obtained number of requests, a respective response time period for returning a response to each of the requests,
when there is a request further made during return of the response, add a response time period for returning a response to the request, and
when there is no request further made during return of the response or when a request is not further made during the added response time period, calculate a time period from initiation of start of a container to completion of a final response time period as a certain time period for the candidate container to be stopped.

9. A non-transitory computer-readable storage medium storing a program that causes a computer to execute a process, the process comprising:
obtaining a service desired by a user;
identifying a resource of the obtained service;
when a container to perform the obtained service is not started in the identified resource, for each of a plurality of candidate containers to be stopped, calculating a degree of influence exerted on the user when a candidate container to be stopped is stopped by using a starting time period of the candidate container, a response time period for the service to be performed, a required resource of a container, and a frequency of a request for the service to be performed;
stopping at least one container for securing the identified resource among the plurality of candidate containers to be stopped based on the calculated degree of influence; and
starting the container to perform the obtained service by using a resource for the at least one container.

10. The storage medium according to claim 9, wherein the calculating includes:
calculating, for each of the plurality of candidate containers to be stopped, a first total response time period taken when the candidate container to be stopped continues to operate without being stopped, the first total response time period being obtained from a frequency of the request within a certain period and the response time period,
calculating, for each of the plurality of candidate containers to be stopped, a second total response time period taken when the candidate container to be stopped is started while stopped, the second total response time period being obtained from the starting time period as well as the frequency of the request within the certain period and the response time period, and
calculating, for each of the plurality of candidate containers to be stopped, a ratio obtained when comparing the second total response time period with the first total response time period, as the degree of influence.

11. The storage medium according to claim 9, wherein the stopping includes
stopping, for securing the identified resource, a container or a container group whose degree of influence is smallest among the plurality of candidate containers to be stopped.

12. The storage medium according to claim 10, wherein the calculating includes:
obtaining a number of requests made during the starting time period of the candidate container to be stopped,
obtaining, for the obtained number of requests, a respective response time period for returning a response to each of the requests,
when there is a request further made during return of the response, adding a response time period for returning a response to the request, and
when there is no request further made during return of the response or when a request is not further made during the added response time period, calculating a time period from initiation of start of a container to completion of a final response time period as a certain time period for the candidate container to be stopped.
